(19) United States
(12) Patent Application Publication
(10) Pub. No.: US 2024/0347687 A1
(43) Pub. Date: Oct. 17, 2024

(54) COMPONENT FOR USE IN AN ENERGY STORAGE DEVICE OR AN ENERGY CONVERSION DEVICE AND METHOD FOR THE MANUFACTURE THEREOF

(71) Applicant: ILIKA TECHNOLOGIES LTD, Romsey Hampshire (GB)

(72) Inventors: Naoum Vaenas, Stratford upon Avon (GB); Donato Ercole Conte, Southampton (GB); Christopher Lee, Southampton Hampshire (GB); Kyriakos Giagloglou, Romsey (GB); John Rice, Southampton (GB)

(73) Assignee: ILIKA TECHNOLOGIES LTD, Romsey Hampshire (GB)

(21) Appl. No.: 18/553,239

(22) PCT Filed: Apr. 29, 2022
(86) PCT No.: PCT/GB2022/051097

§ 371 Date: Sep. 29, 2023

(30) Foreign Application Priority Data
Apr. 29, 2021 (GB) 2106167.6

(51) Int. Cl. H01M 4/04; H01G 13/00; H01M 4/02; H01M 4/131; H01M 4/1391; H01M 4/505; H01M 4/525; H01M 4/66; H01M 4/74

(52) U.S. Cl. CPC H01M 4/0471; H01G 13/00; H01M 4/0404; H01M 4/0414; H01M 4/131; H01M 4/1391; H01M 4/505; H01M 4/525; H01M 4/662; H01M 4/747; H01M 2004/021; H01M 2004/028

(57) ABSTRACT

A method of making a component for an energy storage device or an energy conversion device comprises the steps of: providing a sheet having a plurality of through-thickness apertures: forming a slurry comprising particles of a ceramic material: depositing the slurry onto the sheet having the plurality of through-thickness apertures; and sintering the slurry at a sintering temperature that is greater than 300° C. and less than or equal to 900° C.

### FIELD OF THE INVENTION

The present invention relates to a component for use in an energy storage device or an energy conversion device, in particular to a component for use in batteries, capacitors, fuel cells (including solid oxide fuel cells and polymer electrolyte fuel cells), photovoltaic devices, piezoelectric devices, or thermoelectric converters, and to a method for the manufacture thereof.

### BACKGROUND TO THE INVENTION

Energy storage or energy conversion devices, such as batteries, capacitors, fuel cells (including solid oxide fuel cells and polymer electrolyte fuel cells), photovoltaic devices, piezoelectric devices, or thermoelectric converters typically comprise components that are manufactured through the sintering of ceramic particles.

It is desirable to configure these components so as to improve certain aspects of their performance, such as energy density and/or reliability.

For example, it is desirable to improve the performance of components of battery cells, such as solid-state lithium-ion battery cells.

A solid-state lithium-ion battery cell is a type of rechargeable battery cell in which lithium ions (Li⁺) move from the negative electrode (anode) to the positive electrode (cathode) during discharge and back when charging. The electrodes are each capable of reversibly storing lithium ions and are separated by a solid bulk electrolyte, which allows for ionic transport.

Solid-state battery cells may provide multiple advantages over liquid electrolyte lithium-ion battery cells, such as increased energy density, increased power density, low leakage currents and/or reduced flammability. Thus, solid-state battery cells have been considered for use in, for example, electric vehicles and consumer electronics.

Typically, solid-state battery cells include additional components such as current collectors, interface modifiers and/or encapsulations or other protective elements. In certain cases, the negative electrode is not present in the battery cell immediately after assembly of the cell, but is instead provided as a lithium anode formed during initial charging of the battery cell.

### SUMMARY OF THE INVENTION

In a first aspect, the present invention may provide a method of making a component for an energy storage device or an energy conversion device, comprising the steps of:
providing a sheet having a plurality of through-thickness apertures;
forming a slurry comprising particles of a ceramic material;
depositing the slurry onto the sheet having the plurality of through-thickness apertures; and
sintering the slurry at a sintering temperature that is greater than 300° C. and less than or equal to 900° C.

The term ceramic refers to an inorganic, non-metallic material. The ceramic material may be selected from the group consisting of: electrode active materials; electrolytes; piezoelectric materials; photovoltaic materials; and thermoelectric materials. For the avoidance of doubt, other materials, for example, particles of a further ceramic material, may also be present in the slurry.

The term sintering refers to the process of compacting material that is provided in particulate form by applying heat and optionally pressure to bond the particles. As is well-known to the skilled person, at least a portion of the material remains in the solid state throughout the duration of the sintering process.

The phrase “sintering the slurry” refers to sintering the ceramic particles contained in the slurry. In certain cases, as is known in the art, the slurry may undergo a drying process before the sintering step, so as to evaporate at least a portion of the liquid phase present in the slurry. The drying process is generally carried out at a temperature below 200° C.

For the avoidance of doubt, the sintering temperature is the maximum temperature reached during the sintering step.

Typically, the component is an electrode.

In certain cases, the component may be an electrode for a battery cell, such as a solid state battery cell, and the ceramic material may be an electrode active material. In such cases, the slurry may optionally comprise particles of an electrolyte material and/or other constituents.

In certain cases, the component may be an electrode for a battery cell that comprises a liquid electrolyte. In such cases, the electrodes of the battery cell may be held apart by a separator, such as a porous polymer membrane, while the liquid electrolyte provides an ion-conducting medium that allows for ionic transport between and in certain cases within the electrodes. The sintered nature of an electrode formed according to the method of the invention typically provides enough porosity to allow penetration of the liquid electrolyte into the electrode, thus enhancing ionic transport within the battery and reducing internal resistance.

By depositing the slurry onto the sheet having a plurality of through-thickness apertures, the slurry may penetrate into the sheet, such that the sheet is partially or wholly embedded in the ceramic material. The presence of the partially or wholly embedded sheet may assist in providing a more robust component. For example, the presence of the sheet may allow for easier handling of the component. Furthermore, the penetration of the slurry into the sheet may help to protect the sheet from any aggressive chemicals in the sintering atmosphere. In the case that the component is an electrode for a battery cell and the ceramic material is an electrode active material, the presence of the sheet may help the electrode to withstand volume changes of the electrode during charging or discharging of the battery cell.

Typically, the sintering temperature is in the range 400-900° C. In certain cases, the sintering temperature may be in the range 500-900° C. In certain cases, the sintering temperature may be in the range 600-900° C. For example, the sintering temperature may be in the range 600-800° C. or 600-700° C. The sintering time may be 1-4 hours.

Typically, the ability to sinter the slurry at these sintering temperatures is achieved by including an inorganic sintering aid in the slurry. This form of sintering may be termed liquid phase sintering. When present, the sintering aid is provided by a ceramic material. Typically, the inorganic sintering aid is a ceramic material having a melting point of 900° C. or less. In certain cases, the inorganic sintering aid has a melting point of 850° C. or less, for example, 800° C. or less or 750° C. or less. In certain cases, the melting point of the inorganic sintering aid is 700° C. or less.

The melting point of the inorganic sintering aid may be measured through differential scanning calorimetry of the inorganic sintering aid when provided in bulk form.

In certain cases (for example, where the component is an electrode for a battery cell) the inorganic sintering aid is provided by an ion conductive material having an ionic conductivity greater than 10⁻¹⁰ S cm⁻¹. In certain cases, the ion conductive material has an ionic conductivity greater than 10⁻⁹ S cm⁻¹. In certain cases, the ion conductive material has an ionic conductivity greater than 10⁻⁸ S cm⁻¹. In certain cases, the ion conductive material has an ionic conductivity greater than 10⁻⁷ S cm⁻¹. In certain cases, the ion conductive material has an ionic conductivity greater than 10⁻⁶ S cm⁻¹.

The ionic conductivity of the sintering aid may be determined through analysis of the Nyquist plot obtained through electrochemical impedance spectroscopy at 25° C. of the ion conductive material when provided in bulk form.

The sintering aid may comprise a compound selected from the group consisting of oxides, carbonates (including Li₂CO₃), hydrides (including LiBH₄), halides (including LiF, LiCl, LiBr, and Lil), silicates (including Li₄SiO₄), alkali metal hydroxides (such as LiOH), and mixtures thereof.

In certain cases, the sintering aid may comprise eutectic mixtures of materials, such as LiOH—NaOH eutectic.

In certain cases, the sintering aid may comprise lithium, boron, and optionally carbon as component elements. For example, the sintering aid may comprise Li₃BO₃ (Li₃BO₃ has been shown to have an ionic conductivity of about 6.0×10⁻⁸ S/cm and a melting point of about 800° C.).

In certain cases, the sintering aid may comprise Li₃₋ₓB₁₋ₓCₓO₃, wherein 0<x<1. Li_{2.2}C_{0.8}B_{0.2}O₃, for example, has been shown to have an ionic conductivity of about 8.0×10⁻⁷ S/cm and a melting point of about 685° C. Li₃₋ₓB₁₋ₓCₓO₃ (0.5<x<0.99) has been shown to have a melting point in the range 680° C. to 750° C.

In the case that the component is an electrode for a battery cell and the ceramic material is an electrode active material, the amount of sintering aid in the slurry is in the range 1-50 wt % relative to the total amount of electrode active material, electrolyte material and sintering aid in the slurry, preferably in the range 2-30 wt %.

In the case that the component is an electrode for a battery cell and the ceramic material is an electrode active material, the sintering aid may be present in the slurry in the form of a coating that at least partially covers individual particles of the electrode active and/or electrolyte material.

For the avoidance of doubt, the sintering aid is a solid at 25° C.

In general, it is desirable that the sheet is secured to a substrate (or support surface), before the step of depositing the slurry onto the sheet. This helps to ensure that the sheet (and hence the faces of the component) are generally planar. This is particularly desirable in the case that the component is an electrode for a battery cell, as this helps to ensure that the thickness of the electrolyte separating the positive and negative electrodes in the battery is substantially constant, thus helping to reduce the risk of a short circuit between the two electrodes.

Typically, the sheet is secured to the substrate by means of a polymer-based adhesive, for example, an adhesive tape.

In certain cases, the slurry is deposited onto the sheet by means of a sheet-to-sheet process. A sheet-to-sheet process is typically an intermittent process, and may comprise processes such as tape-casting or screen-printing. In other cases, the deposition process may be a roll-to-roll process. A roll-to-roll process is typically a continuous process, and may comprise processes such as comma bar, K-bar, doctor blade, slot die, flexographic, gravure, intaglio and lithographic coating methods. Detailed descriptions and requirements for these processes are given in “The Printing Ink Manual” R. H. Leach and R. J. Pierce eds. 5th ed 1993 (ISBN 0 9448905 81 6), which is hereby incorporated by reference.

In general, the sheet having the plurality of through-thickness apertures is an electronically conductive sheet. For example, the sheet may comprise a metal or a metal alloy. In certain cases, the sheet may comprise iron or steel (including stainless steel, that is, steel containing at least 10 wt % chromium). For example, the sheet may comprise stainless steel that contains chromium, nickel and molybdenum. In certain cases, the stainless steel may comprise 15-20 wt % chromium, 10⁻¹⁵ wt % nickel and 1-5 wt % molybdenum. In certain cases, the stainless steel may have a low carbon content, that is, 0.05 wt % or less, in certain cases 0.03 wt % or less.

In the case that the component is an electrode for a battery cell and the ceramic material is an electrode active material, such an electronically-conductive sheet may replace the current collector for the electrode and/or may reduce or eliminate the need for an additional electronically-conductive component to be included in the slurry. Thus, the energy density of the battery cell may be increased. Furthermore, since the sheet is partially or wholly embedded in the electrode active material, the interfacial contact area between the electrode active material and the sheet may be increased relative to a configuration in which a current collector is provided as a discrete layer having a planar interface with an electrode. Thus, the internal resistance of the battery cell may be reduced.

In such cases, the amount of any additional electronically-conductive constituent in the slurry may be less than 10 vol % relative to the total volume of the particles of electrode active material. Preferably, the amount of any additional electronically-conductive constituent in the slurry is less than 5 vol % relative to the total volume of the particles of electrode active material. More preferably, the amount of any additional electronically-conductive constituent in the slurry is less than 2 vol % relative to the total volume of the particles of electrode active material. Even more preferably, the amount of any additional electronically-conductive constituent in the slurry may be less than 1 vol % relative to the total volume of the particles of electrode active material.

When present, the additional electronically-conductive constituent typically has an electronic conductivity of at least 10⁻⁴ Scm⁻¹, determined through DC decay measurement at 25° C. In certain embodiments, the electronic conductivity of the additional electronically-conductive constituent may be at least 10⁻³ Scm⁻¹. In certain embodiments, the electronic conductivity of the additional electronically-conductive constituent may be at least 10⁻² Scm⁻¹. In certain embodiments, the electronic conductivity of the additional electronically-conductive constituent may be at least 10⁻¹ Scm⁻¹. In certain embodiments, the electronic conductivity of the additional electronically-conductive constituent may be at least 1 Scm⁻¹. In certain embodiments, the electronic conductivity of the additional electronically-conductive constituent may be at least 10 Scm⁻¹.

When present, the electronically-conductive constituent may comprise a material selected from the group consisting of: carbon black, acetylene black, activated carbon, carbon nanotubes, carbon fibres, titanium nitride, indium tin oxide; antimony tin oxide; vanadium pentoxide; non-stoichiometric molybdenum nitride; aluminium-doped zinc oxide; tantalum carbide; and mixtures thereof. Alternatively, the electronically-conductive constituent may be provided by a metal powder.

In general, the sheet having the plurality of through-thickness apertures is provided by a woven mesh. Woven meshes, generally comprising strands of a metal or metal alloy, are commercially available in different varieties, having different numbers of strands per unit distance measured in a direction perpendicular to the strands. When a mesh has a low number of strands per unit distance, the individual strands tend to have a high thickness and thus the mesh weight per unit area tends to be high. Therefore, it is generally preferable to avoid meshes having a very low number of strands per unit distance.

Typically, the woven mesh has 5-500 strands per cm, when measured in a direction perpendicular to the strands. In certain cases, the woven mesh has 30-250 strands per cm, when measured in a direction perpendicular to the strands. In other cases, the woven mesh has 30-100 strands per cm, when measured in a direction perpendicular to the strands.

The weave style of the mesh is not particularly limited. Typically, the weave style is a plain weave, in which each strand passes alternately over and under the strands that are oriented transversely to it.

In general, the through-thickness apertures of the sheet have a width in the range 10⁻¹⁰⁰⁰ μm. For example, the apertures may have a width in the range 10⁻²⁰⁰ μm. In certain cases, the apertures may have a width in the range 50-200 μm.

The width of the aperture is the lesser dimension of the aperture in the plane of the sheet. Typically, the apertures have a square shape. In such cases, the width of the aperture corresponds to the length of one side of the square. In certain cases, the apertures may be circular. In such cases, the width of the aperture corresponds to the diameter of the circle. In certain cases, the apertures may have a rectangular shape. In such cases, the width of the aperture corresponds to the length of the shorter sides of the rectangle.

In general, the apertures are arranged in a regular array.

In certain cases, the sheet having the plurality of through-thickness apertures may be provided by a sheet having a plurality of through-thickness perforations, such as a grating.

For the avoidance of doubt, the term “through-thickness aperture” refers to an aperture that extends in a transverse direction of the sheet, directly from a first face of the sheet to a second, opposing face of the sheet.

In the case that the component is an electrode for a battery cell and the ceramic material is an electrode active material, the choice of the electrode active material is not particularly limited.

Typically, in the case that the electrode is intended for use as an anode of a battery cell, the electrode active material is selected from the group consisting of the elements lithium, silicon, carbon, tin, magnesium, aluminium, titanium, boron, and iron, and combinations thereof. Alternatively, the electrode active material may be comprise phosphates, nitrides, and/or oxides of these elements. Specific examples of possible compounds for use in an anode include lithium titanium oxide (Li₄Ti₅O₁₂ or Li₂TiO₃) and SnO₂.

Conversely, in the case that the electrode is intended for use as a cathode of a battery cell, the electrode active material is typically a compound containing the cations of lithium and one or more transition metals, and an anion selected from the group consisting of: oxide anion, sulphide anion, and polyanions. Examples of suitable polyanions include phosphate, PO₄F, and SO₄F.

For example, where the electrode is intended for use as a cathode, the electrode active material may be selected from the group consisting of lithium nickel cobalt aluminium oxide (LiNi_{0.8}CO_{0.15}Al_{0.05}O₂); lithium cobalt oxide (LiCoO₂); lithium iron phosphate (LiFePO₄); lithium manganese nickel oxide (LiMn_{1.5}Ni_{0.5}O₄); lithium cobalt phosphate (LiCoPO₄); lithium nickel cobalt manganese oxide (LiNiₓCo_{y}Mn₂O₂ wherein x>0; y>0; z>0 and x+y+z=1); vanadium oxide (V₂O₅); LiVOPO₄; Li₃V₂(PO₄)₃; and combinations thereof. Metal chalcogenides such as TiS₃, NbSe₃, LiTiS₂ and combinations thereof may also provide suitable electrode active materials in the case that the battery electrode is intended for use as a cathode.

Descriptions of suitable electrode active materials for both anodes and cathodes may be found in Nitta et al, Materials Today, 2015, 18, 252-264, which is hereby incorporated by reference.

Typically, the particles of the ceramic material (for example, an electrode active material) have a d50 size in the range 10 nm to 50 μm, measured using laser diffraction of a liquid dispersion of the particles, following ISO 13320:2020. For example, the particles of the ceramic material may have a d50 size in the range 100 nm to 40 μm. In certain cases, the particles of the ceramic material may have a d50 size in the range 1-40 μm. In certain cases, the particles of the ceramic material may have a d50 size in the range 2-20 μm.

In the case that the component is an electrode for a battery cell and the ceramic material is an electrode active material, particles of an electrolyte material are optionally present in the slurry. This may help to increase the ionic conductivity of the resultant electrode. The choice of the electrolyte material is not particularly limited. Typically, the electrolyte material is a lithium-containing electrolyte material. For example, the electrolyte material may be a lithium garnet electrolyte material. In certain cases, the electrolyte material may be a lithium-containing oxide material. For example, the electrolyte material may be selected from the group consisting of: lithium lanthanum zirconium oxide (LLZO) and cation-doped LLZO, wherein the cation dopant may be selected from the group consisting of tantalum, barium, yttrium, zinc, niobium, aluminium, germanium, strontium, gallium, titanium, and combinations thereof.

Typically, the particles of the electrolyte material have a greater ionic conductivity than the inorganic sintering aid. In general, the particles of the electrolyte material have a melting point above 900° C.

The particle size of the electrolyte material is generally smaller than that of the electrode active material.

Typically, the slurry formed in the method according to the first aspect of the invention also comprises an organic binder phase and a solvent for the organic binder phase.

The choice of the organic binder is not particularly limited, as long as it performs the function of providing the slurry with a degree of mechanical strength after deposition and before sintering. For example, the organic binder may be selected from the group consisting of vinyl polymers (including polyvinyl alcohol, polyvinyl butyral, polyvinyl chloride, polyvinyl butanol, polyvinyl acetate and vinyl chloride-acetate); acrylic polymers (including polyacrylate esters, polymethyl methacrylate, and polyethyl methacrylate); cellulose binders (including ethyl cellulose, methyl cellulose, carboxymethyl cellulose, hydroxyethyl cellulose, hydroxypropyl methyl cellulose, nitrocellulose, and cellulose acetate-butyrate); polypropylene carbonate; polyethylene carbonate; and polyethylene oxide. Preferably, the organic binder is selected from the group consisting of ethyl cellulose, polypropylene carbonate, polyethylene carbonate, polyvinyl alcohol, polyethylene oxide, and carboxymethyl cellulose.

In general, the amount of organic binder in the slurry is in the range 1-20 wt % relative to the total amount of solid material in the slurry, preferably in the range 5-15 wt %.

The solvent is typically an organic solvent and may be selected from the group consisting of terpineol, benzyl alcohol, toluene, xylenes, ethanol, methanol, methyl ethyl ketone, ethylene glycol ethyl ether, ethylene glycol monobutyl ether, diethylene glycol monoethyl ether, diethylene glycol monomethyl ether, diethylene glycol ethyl isobutyl ether, neopentyl glycol monoisobutyrate, diethylene glycol monobutyl ether, ethylene glycol ether, diethylene glycol monohexyl ether, propylene glycol monobutyl ether, diethylene glycol monoethyl ether acetic ester, ethylene glycol monomethyl ether acetate, ethylene glycol monoethyl ether acetate, butyl carbitol acetate, acetate 2-butoxy ethyl ester, acetate 2-ethoxy ethyl ester, acetate 2-methoxyl group ethyl ester; 2,2,4-trimethyl-1,3-pentanediol monoisobutyrate (texanol™), C10-C40 alcohols, ethyl lactate, dipropylene glycol monomethyl ether, 2 ethyl hexanoic acid, tri-methyl hexanoic acid, tetrahydrofurfuryl alcohol, furfuryl alcohol, 2-(benzyloxy) ethanol, 2-phenoxyethyl alcohol, 2-(methoxymethoxy) ethanol, triethylene glycol monomethyl ether, triethylene glycol, diethylene glycol monobutyl acetic ester, butyl carbitol acetate, phenylium ester, phenoxy group ethylhexoate, glycol monomethyl phenyl ether, diethylene glycol phenyl ether, glycol monomethyl benzylic ether, diethylene glycol single-benzyl ether, propylene glycol phenyl ether, benzyl glycol, phenylacetic acid methyl esters, phenylacetic acid ethyl ester, ethyl benzoate, methyl benzoate, gamma-butyrolactone, dimethyl sulfoxide (DMSO), N-methyl pyrrolidone, N-methylacetamide, ethanamide, N-dimethylformamide, N-methylformamide, methane amide, and combinations thereof.

The slurry may further comprise a dispersant and/or a plasticiser.

Typically, the slurry is deposited on the sheet in an amount such that the thickness of the component after sintering is greater than the thickness of the sheet. That is, typically, the amount of slurry that penetrates into the apertures of the sheet is only a portion of the total amount of slurry that is deposited. In general, the slurry is deposited on the sheet in an amount such that the thickness of the component after sintering is at least 30% greater than the thickness of the sheet. In certain cases, the thickness of the component after sintering is at least 50% greater than the thickness of the sheet. In certain cases, the thickness of the component after sintering is at least 80% greater than the thickness of the sheet.

In certain cases, the sheet is indirectly secured to the substrate (or support surface) by means of a mask, instead of being secured directly to the substrate, for example by means of a polymer-based adhesive. In such cases, the method may further comprise the step, before the step of depositing the slurry onto the sheet, of:
providing a support surface and a mask, wherein the mask comprises at least one window;
placing the sheet between the support surface and the mask, such that a first face of the sheet faces towards the mask, wherein a first portion of the sheet is shielded by the mask and a second portion of the sheet is exposed through the window of the mask; and
reversibly securing the mask to the support surface.

In general, the mask is reversibly secured to the support surface using magnetic means. That is, typically, one of the mask and the support surface is magnetised and the other of the mask and the support surface comprises a magnetic material. In a preferred case, the support surface is magnetised and the mask comprises a magnetic material, for example, ferromagnetic steel. It is thought that this allows a thin mask to be provided, which may ease the process of depositing the slurry onto the sheet.

In certain cases, the mask may be reversibly secured to the support surface using one or more mechanical fasteners. However, this is less preferred, as it is thought the mechanical fasteners may impede slurry deposition.

In certain cases, the method may further comprise the steps, between the steps of depositing the slurry and sintering the slurry, of:
detaching the mask from the support surface;
reversing the sheet such that the first face of the sheet faces towards the support surface;
placing the mask over the sheet and reversibly securing the mask to the support surface; and
depositing an additional quantity of slurry comprising particles of the ceramic material onto a portion of a second face of the sheet that is opposed to the first face of the sheet.

Typically, before the step of reversing the sheet, the deposited slurry is dried so as to evaporate at least part of the liquid phase of the slurry.

Preferably, the slurry is deposited to a first thickness and the additional quantity of slurry is deposited to a second thickness, wherein the ratio of the first and second thicknesses lies between 0.5 and 2. Thus, the sheet may positioned in a substantially central plane of the component. This may be particularly advantageous in the case that the sheet is electrically-conductive and functions as a current collector.

In certain cases, the method may comprise the further steps, between the steps of depositing the slurry onto a sheet that is indirectly secured to the support surface by means of a mask, so that a first portion of the sheet is shielded by the mask, and sintering the slurry, of:
detaching the mask from the support surface;
bending the sheet, such that a part of the first portion of the sheet overlies the deposited slurry;
reversibly securing the mask to the support surface, such a part of the first portion of the sheet is exposed through the window of the mask; and
depositing a further quantity of slurry comprising particles of the ceramic material onto the exposed part of the first portion of the sheet.

In certain cases, after the steps of bending the sheet and reversibly securing the mask to the support surface, a further part of the first portion of the sheet is shielded by the mask; and the method comprises the further steps, between the steps of depositing the further quantity of slurry and sintering the slurry, of:
detaching the mask from the support surface;
bending the sheet, such that the further part of the first portion of the sheet at least partly overlies the further quantity of slurry;
reversibly securing the mask to the support surface, such that the further part of the first portion of the sheet is at least partly exposed through the window of the mask; and
depositing a still further quantity of slurry comprising particles of the ceramic material onto the exposed part of the further part of the first portion of the sheet.

These optional method steps may provide a sheet that is bent back on itself one or more times within the component. This may be particularly advantageous in the case that the sheet is electrically-conductive and functions as a current collector, as it may facilitate electronic conduction within the bulk volume of the component.

An alternative approach to providing a sheet that is bent back on itself one or more times within the component may comprise the step, after the step of depositing the slurry onto the sheet having the plurality of through-thickness apertures and before the step of sintering the slurry, of folding the sheet, so that a first portion of the sheet overlies a second portion of the sheet, both the first and second portions of the sheet lying within the region of the sheet onto which the slurry was deposited. In general, before the step of folding the sheet, the deposited slurry is dried so as to evaporate at least part of the liquid phase of the slurry. Typically, after the step of folding the sheet, but before or during the step of sintering the deposited slurry, pressure is applied in a through-thickness direction of the first and second portions of the sheet.

In a second aspect, the present invention may provide a method of making a battery cell,
comprising the steps of:
making a component according to the method of the first aspect of the invention, wherein the component is an electrode and the ceramic material is an electrode active material;
fixing the electrode to a substrate; and
depositing a further battery layer onto the electrode.

The step of fixing the electrode to the substrate may be carried out using a polymer-based adhesive, as described in relation to the first aspect of the invention. However, the sintered electrode typically has enough stiffness to allow the use of spot-welding for this step as an alternative to the polymer-based adhesive.

Typically, the battery cell is a solid state battery cell.

In a third aspect, the present invention may provide a component for use in an energy storage or an energy conversion device, the component being obtained or obtainable through the method according to the first aspect of the invention.

Typically, the component comprises a sintered, ceramic-containing body in which the sheet having a plurality of through-thickness apertures is partially or wholly embedded.

In certain cases, the component is an electrode for a battery cell. In such cases, the electrode may have a thickness in the range 70-1000 μm. In certain cases the component is an electrode for a solid state battery cell.

In a fourth aspect, the present invention may provide a component for use in an energy storage device or an energy conversion device, the component comprising a first part and a second part, wherein the first part comprises particles of a ceramic material, and the second part is provided by a sheet having a plurality of through-thickness apertures;
wherein the second part is at least partially embedded in the first part.

The term ceramic refers to an inorganic, non-metallic material. The ceramic material may be selected from the group consisting of: electrode active materials; electrolytes; piezoelectric materials; photovoltaic materials; and thermoelectric materials. For the avoidance of doubt, other materials, for example, particles of a further ceramic material, may also be present in the first part. The second part may be partially or wholly embedded in the first part.

In general, the thickness of the component is greater than the thickness of the sheet. For example, the thickness of the component may be at least 30% greater than the thickness of the sheet. In certain cases, the thickness of the component is at least 50% greater than the thickness of the sheet. In certain cases, the thickness of the component is at least 80% greater than the thickness of the sheet.

In general, the particles of the ceramic material are connected to provide a self-supporting network. Effectively, the first part may be provided by a sintered, ceramic-containing body. Typically, the component is an electrode.

In certain cases, the component is an electrode for a battery cell, such as a solid state battery cell, and the ceramic material is an electrode active material. In such cases, the electrode may additionally comprise particles of an electrolyte material and/or other constituents. The electrode for the battery cell may have a thickness in the range 70-1000 μm.

Typically, the first part comprises a sintering aid as described in relation to the first aspect of the invention. In the case that the component is an electrode for a battery cell and the ceramic material is an electrode active material, the amount of sintering aid in the electrode is typically in the range 1-50 wt % relative to the total amount of electrode active material, electrolyte material and sintering aid, preferably in the range 2-30 wt %. In such cases, the sintering aid may be present in the form of a coating that at least partially covers individual particles of the electrode active and/or electrolyte material.

The sheet having the plurality of through-thickness apertures may have one or more of the optional features of the corresponding sheet described in relation to the first aspect of the invention.

In the case that the sheet is an electronically-conductive sheet and the component is an electrode for a battery cell, the need for an additional electronically-conductive constituent in the first part of the electrode may be reduced or eliminated. Where such an additional electronically-conductive constituent is present, it may have one or more of the optional features described in relation to the corresponding constituent of the first aspect of the invention and/or may be present in the amount described in relation to the corresponding constituent of the first aspect of the invention.

In the case that the component is an electrode for a battery cell and the ceramic material is an electrode active material, the particles of electrode active material may have one or more of the optional features of the corresponding particles described in relation to the first aspect of the invention. In the case that the first part of the electrode additionally contains particles of an electrolyte material, these may have one or more of the optional features of the corresponding particles described in relation to the first aspect of the invention.

In a fifth aspect, the present invention may provide an energy storage device or energy conversion device comprising a component according to the third or fourth aspects of the invention. The device may be selected from the group consisting of: batteries (including solid state batteries), capacitors, fuel cells (including solid oxide fuel cells and polymer electrolyte fuel cells), photovoltaic devices, piezoelectric devices, and thermoelectric converters.

In a sixth aspect, the present invention may provide a solid state battery cell comprising a component according to the third or fourth aspects of the invention, wherein the component is an electrode, the battery cell further comprising an electrolyte layer disposed on a face of the electrode.

### DETAILED DESCRIPTION

The invention will now be described by way of example with reference to the following Figures in which:

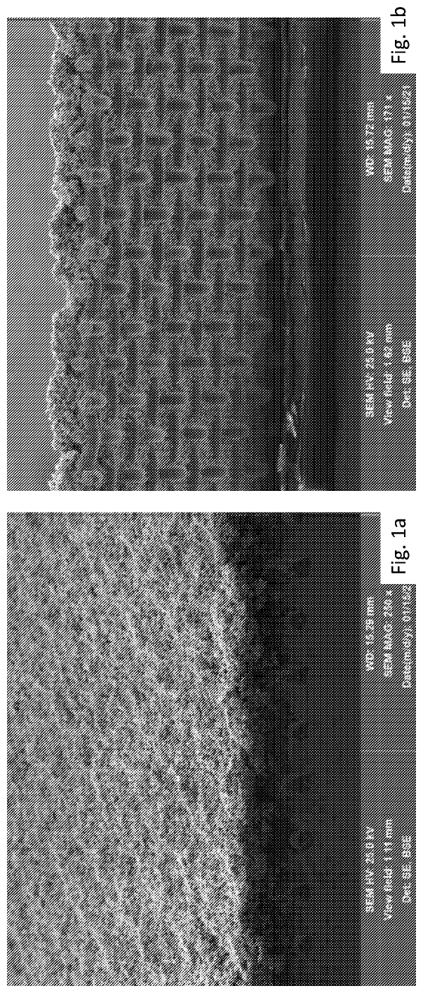

FIGS. 1a and 1b show scanning electron micrographs of the two faces (top and bottom) of the sintered cathode of Example 1;

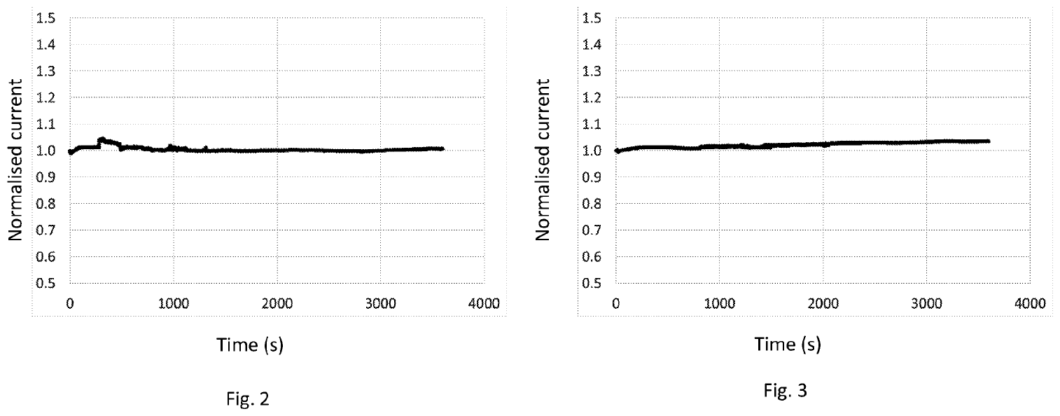

FIG. 2 shows a graph of electrical current against time for the sintered cathode of Example 2. The electrical current is normalised with respect to the first reading obtained;

FIG. 3 shows a graph of electrical current against time for the sintered cathode of Example 3. The electrical current is normalised with respect to the first reading obtained;

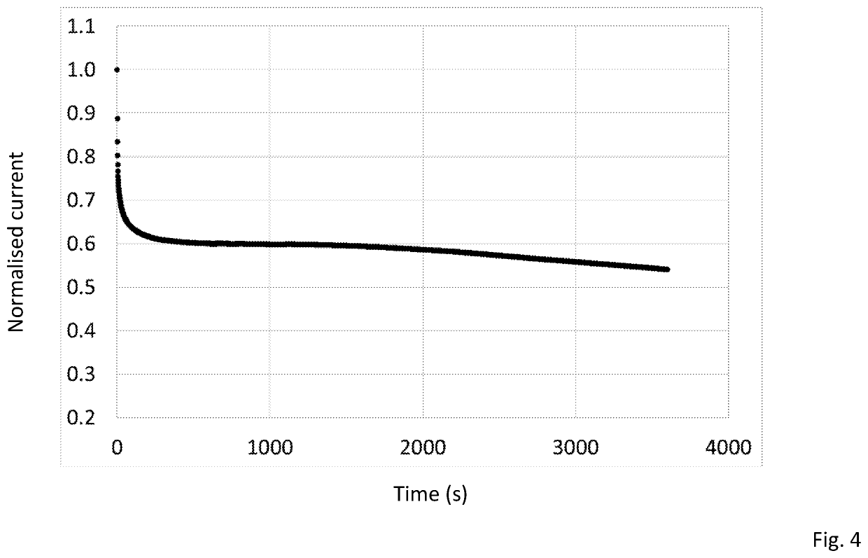

FIG. 4 shows a graph of electrical current against time for the sintered cathode of the Comparative Example. The electrical current is normalised with respect to the first reading obtained;

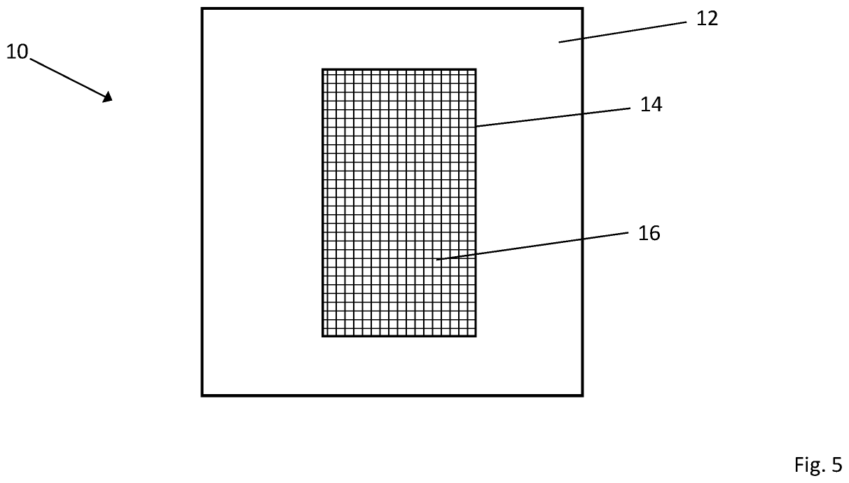

FIG. 5 shows a schematic plan view of an apparatus for use in a method according to an example of the invention;

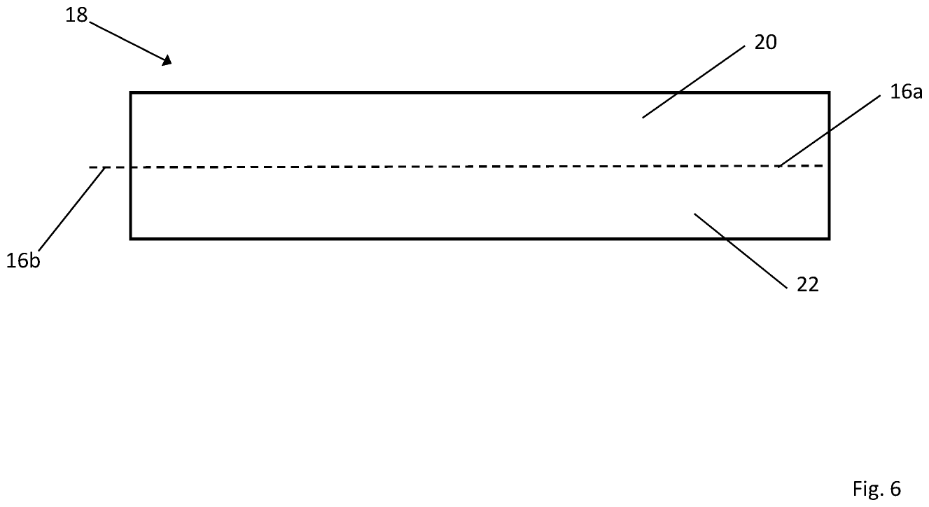

FIG. 6 shows a schematic cross-sectional view of a component according to a first embodiment of the fourth aspect of the invention;

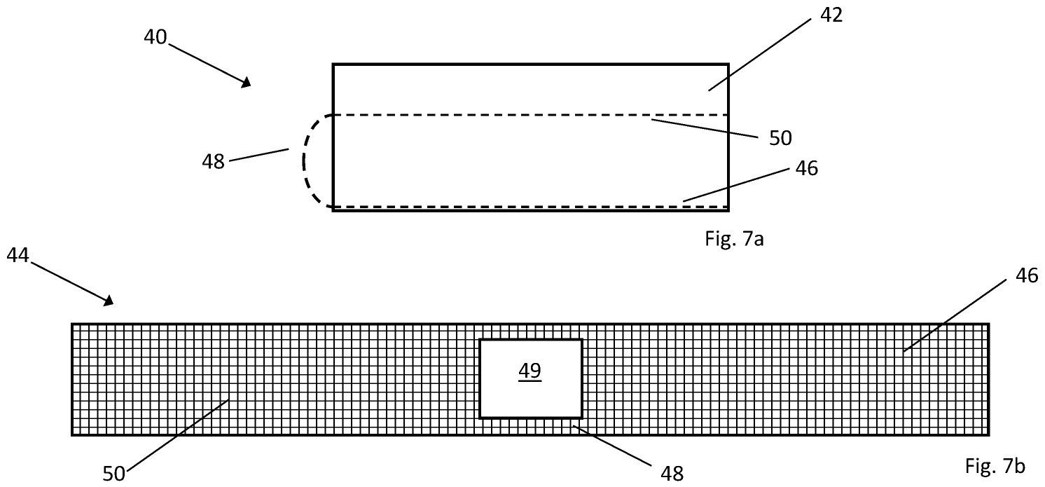

FIG. 7a shows a schematic cross-sectional view of a component according to a second embodiment of the fourth aspect of the invention;

FIG. 7b shows a schematic plan view of the mesh provided in the component of FIG. 7a, prior to assembly of the component.

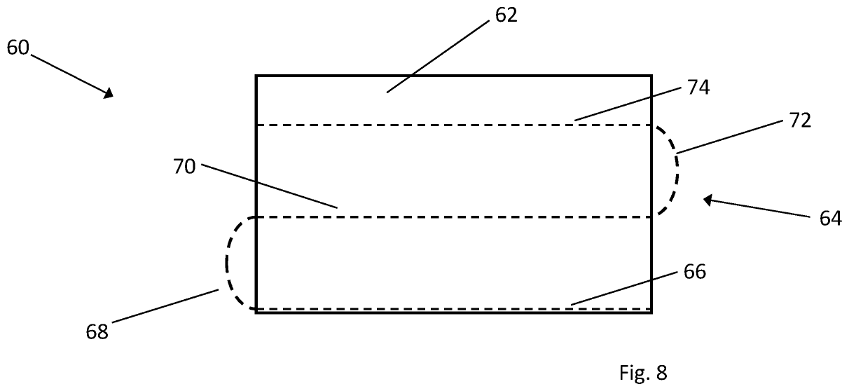

FIG. 8 shows a schematic cross-sectional view of a component according to a third embodiment of the fourth aspect of the invention.

### CATHODE PREPARATION

Slurries were prepared from the constituents set out in Table 1.

TABLE 1

| Slurry constituent | Function | Amount | |
|---|---|---|---|
| Particles of NMC | Cathode active material | 35 | wt % |
| Particles of LLZTO | Electrolyte material | 18-22 | wt % |
| Particles of LCBO | Sintering aid | 3-7 | wt % |
| Ethyl cellulose | Binder phase | 2 | wt % |
| Terpineol | Solvent for binder phase | 38 | wt % |

The NMC cathode active material had the chemical formula LiNi_{0.33}Mn_{0.33}Co_{0.33}O₂.

The LLZTO electrolyte had the chemical formula Li_{6.4}La₃Zr_{1.4}Ta_{0.8}O₁₂.

The LCBO sintering aid had the chemical formula Li_{2.3}C_{0.7}B_{0.3}O₃, and was prepared by heating a mixture of 10 g Li₂CO₃ and 5 g LisBO₃ in air at 650° C. for 12 hours.

A woven metal mesh was attached to a fixed substrate using adhesive tape. Then, the slurry was cast onto the metal mesh using a screen printing process and dried. 4-6 layers of the slurry were cast in total before drying.

The sample was sintered in a Carbolite GSM1100 furnace in argon.

Impedance measurements were taken on the sintered samples by sputtering 5 mm diameter circle Au contacts of 100 nm thickness on to the top surface of the sample using a Leica Sputter coater. Impedance was then measured on a Solartron Impedance Analyser.

The electronic conductivity of the electrode was measured by applying a constant voltage of 1V and measuring the current for 1 hour. The current was measured using a Keithley Source Meter.

Further details of the Examples are set out in Table 2.

TABLE 2

| | | | Aperture | | Specimen |
|---|---|---|---|---|---|
| | Mesh | Strands/ | size | | thickness after |
| Example | size | cm | (μm) | Mesh material | sintering (μm) |
| 1 | 200 | 78.7 | 70 | Stainless steel | 200 |
| 2 | 200 | 78.7 | 70 | Stainless steel | 150 |
| 3 | 500 | 196.9 | 26 | Stainless steel | 85 |

FIGS. 1a and 1b show SEM images of Example 1. These show that the cathode slurry has penetrated the mesh and formed a homogeneous and dense film that has a controlled thickness.

FIGS. 2 and 3 show that a constant electrical current may be maintained across the sintered cathode. That is, no direct current decay is observed, meaning that an electronically-conductive network has been established.

### Comparative Example

A Comparative Example was prepared in which the slurry of Table 1 was cast onto a stainless steel foil (that is, a sheet not containing through-thickness apertures). Two layers of slurry were cast in total and the sample was dried and sintered. The sintered specimen had a thickness of 40 μm.

FIG. 4 shows significant direct current decay is observed in the absence of any electronically-conductive constituent in the slurry, despite the fact that the thickness of the electrode is less than half that of Examples 1-3.

### Preparation of Battery Cell

A cathode slurry was prepared, cast onto a woven mesh having a mesh size of 200, and dried, as described above.

As described above, the woven mesh was secured to a fixed substrate using adhesive tape before deposition of the cathode slurry.

Then, an electrolyte slurry was prepared from LLZTO and LCBO particles, a binder phase and a solvent, cast onto the cathode layer, and dried.

The two cast and dried layers were sintered using the same sintering conditions set out above in relation to the cathode layer.

The sintering process caused the adhesive tape used to secure the woven mesh to burn out.

Therefore, after sintering, the cathode and electrolyte stack were secured to the fixed substrate by means of spot welding.

Then, a slurry containing silicon particles was deposited onto the electrolyte layer and dried to provide a battery cell.

### Example 4

Referring to FIG. 5, an apparatus 10 for preparing a component such as the cathode of a battery cell is shown. The apparatus comprises a support surface (not shown), which is typically provided by a steel plate. A mask 12 is placed on the support surface. The mask 12 comprises a window 14.

To prepare the component, a mesh 16, for example, one of the meshes described in Table 2, is placed between the mask 12 and the support surface, such that a first face of the mesh 16 faces towards the mask 12 and a second face of the mesh 16 faces towards the support surface. A first portion of the mesh 16 is exposed through the window 14 of the mask 12, while a second portion of the mesh is shielded by the mask.

The mask 12 is reversibly secured to the support surface by magnetic means. For example, the steel plate of the support surface may magnetised and the mask 12 may comprise a ferromagnetic material, such as ferromagnetic stainless steel.

A quantity of slurry, such as the slurry described in Table 1, is deposited on the mask 12 by tape casting or screen printing, and penetrates into the portion of the mesh 16 that is exposed through the window 14 of the mask. This first slurry layer is then allowed to dry, for example, on a belt drier.

The mask 12 is then detached from the support surface and the mesh 16 reversed, such that the first face of the mesh faces towards the support surface. The mask 12 is then reversibly secured to the support surface such that the position of the window 14 coincides with the portion of the mesh 16 into which the slurry has penetrated. A second slurry layer is then deposited onto the mask 12, so as to cover the portion of the mesh 16 that is exposed through the window 14.

The two slurry layers are dried and sintered. Subsequently, the mesh 16 is trimmed, so as to largely remove the portion that is free of slurry, while leaving a mesh tab that protrudes from the slurry layers. The resulting component 18 is shown in FIG. 6, which shows the two sintered slurry layers 20,22 located on opposite sides of the trimmed mesh 16a. The mesh tab 16b allows an external electrical connection to be provided to the mesh. The thicknesses of the two layers 20,22 are substantially equal.

### Example 5

Referring to FIG. 7a, a component 40 suitable for the cathode of a battery cell comprises a sintered part 42 comprising particles of an electrode active material and a mesh 44 that is embedded in the sintered part. FIG. 7b shows the mesh 44 prior to manufacture of the component 40.

The mesh 44 has a first portion 46 and a second portion 50 that are connected by a linking portion 48. The first and second portions 46,50 of the mesh may have the features of one of the meshes described in Table 2. The linking portion of the mesh comprises a large-scale through-thickness opening 49 that spans multiple strands of the mesh, to reduce the weight of the mesh.

Component 40 is prepared by depositing a first slurry layer on the first portion 46 of the mesh (the slurry may correspond to the slurry described in Table 1). During deposition of the slurry, the mesh is secured between a mask and a support surface, as described in relation to Example 4, to ensure that the mesh remains flat and slurry is only deposited onto the first portion of the mesh.

The mask is then removed from the mesh, and the mesh is bent at the linking portion 48, so that the second portion 50 overlies the first slurry layer. The resultant assembly is placed between the mask and the support surface, as described in relation to Example 4, so that the mesh is maintained in its bent configuration and the second portion 50 of the mesh is exposed through the window of the mask. A second slurry layer is then deposited onto the second portion 50 of the mesh.

### Example 6

Referring to FIG. 8, a component 60 suitable for the cathode of a battery cell comprises a sintered part 62 comprising particles of an electrode active material and a mesh 64 that is embedded in the sintered part.

The mesh 64 comprises first, second and third portions 66,70,74 that are aligned with each other and that are displaced relative to each other in the through-thickness direction of the component. The first and second portions 66,70 are linked by a first linking portion 68, and the second and third portions 70,74 are linked by a second linking portion 72.

1. A method of making a component for an energy storage device or an energy conversion device, comprising the steps of:
providing a sheet having a plurality of through-thickness apertures;
forming a slurry comprising particles of a ceramic material;
depositing the slurry onto the sheet having the plurality of through-thickness apertures; and
sintering the slurry at a sintering temperature that is greater than 300° C. and less than or equal to 900° C.

2. The method according to claim 1, wherein the ceramic material is selected from the group consisting of: electrode active materials; electrolytes; piezoelectric materials; photovoltaic materials; and thermoelectric materials.

3. The method according to claim 2, wherein the component is an electrode for a battery cell, particularly a solid state battery cell, and the ceramic material is an electrode active material.

4. The method according to claim 3, wherein the slurry further comprises an inorganic sintering aid, the inorganic sintering aid being provided by an ion conductive material having an ionic conductivity greater than 10⁻¹⁰ S cm⁻¹ and a melting point of 900° C. or less.

5. The method according to claim 4, wherein the sintering aid comprises lithium, boron, and optionally carbon as component elements.

6. The method according to claim 5, wherein the sintering aid is selected from the group consisting of Li3BO3 and Li3-xB1-xCxO3, wherein 0<x<1

7. The method according to claim 1, further comprising the step, before the step of depositing the slurry onto the sheet, of securing the sheet to a substrate.

8. The method according to claim 7, wherein the sheet is secured to the substrate by means of a polymer-based adhesive.

9. The method according to claim 1, further comprising the step, before the step of depositing the slurry onto the sheet, of:
providing a support surface and a mask, wherein the mask comprises at least one window;
placing the sheet between the support surface and the mask, such that a first face of the sheet faces towards the mask, wherein a first portion of the sheet is shielded by the mask and a second portion of the sheet is exposed through the window of the mask; and
reversibly securing the mask to the support surface.

10. The method according to claim 9, wherein the mask is reversibly secured to the support surface using magnetic means.

11. The method according to claim 10, wherein one of the mask and the support surface is magnetised and the other of the mask and the support surface comprises a magnetic material.

12. The method according to claim 9, comprising the further steps, between the steps of depositing the slurry and sintering the slurry, of:
detaching the mask from the support surface;
reversing the sheet such that the first face of the sheet faces towards the support surface;
placing the mask over the sheet and reversibly securing the mask to the support surface; and
depositing an additional quantity of slurry comprising particles of the ceramic material onto a portion of a second face of the sheet that is opposed to the first face of the sheet.

13. The method according to claim 12, wherein the slurry is deposited to a first thickness and the additional quantity of slurry is deposited to a second thickness, wherein the ratio of the first and second thicknesses lies between 0.5 and 2.

14. The method according to claim 9, comprising the further steps, between the steps of depositing the slurry and sintering the slurry, of:
detaching the mask from the support surface;
bending the sheet, such that a part of the first portion of the sheet overlies the deposited slurry;
reversibly securing the mask to the support surface, such a part of the first portion of the sheet is exposed through the window of the mask; and
depositing a further quantity of slurry comprising particles of the ceramic material onto the exposed part of the first portion of the sheet.

15. The method according to claim 14, wherein after the steps of bending the sheet and reversibly securing the mask to the support surface, a further part of the first portion of the sheet is shielded by the mask; and the method comprises the further steps, between the steps of depositing the further quantity of slurry and sintering the slurry, of:
detaching the mask from the support surface;
bending the sheet, such that the further part of the first portion of the sheet at least partly overlies the further quantity of slurry;
reversibly securing the mask to the support surface, such that the further part of the first portion of the sheet is at least partly exposed through the window of the mask; and
depositing a still further quantity of slurry comprising particles of the ceramic material onto the exposed part of the further part of the first portion of the sheet.

16. The method according to claim 1, wherein the slurry is deposited onto the sheet by means of a tape-casting or screen-printing process.

17. The method according to claim 1, wherein the sheet having the plurality of through-thickness apertures is an electronically conductive sheet.

18. The method according to claim 17, wherein the sheet comprises a metal or a metal alloy.

19. The method according to claim 18, wherein the sheet comprises iron or steel.

20. The method according to claim 17, wherein the ceramic material is an electrode active material and the amount of any solid electronically-conductive component in the slurry is less than 10 vol % relative to the total volume of the particles of the electrode active material.

21. The method according to claim 1, wherein the particles of the ceramic material have a D50 particle size in the range 10 nm to 50 μm.

22. The method according to claim 1, wherein the sheet is provided by a woven mesh.

23. The method according to claim 22, wherein the woven mesh has 5-500 strands per cm, when measured in a direction perpendicular to the strands.

24. The method according to claim 1, wherein the apertures have a width in the range 10⁻¹⁰⁰⁰ μm.

25. A method of making a battery cell, comprising the steps of:
making a component according to the method of claim 1 claims, wherein the component is an electrode and the ceramic material is an electrode active material;
fixing the electrode to a substrate; and
depositing a further battery layer onto the electrode.

26. The method according to claim 25, wherein the step of fixing the electrode to the substrate comprises spot welding the electrode to the substrate.

27. A component for use in an energy storage or an energy conversion device, the component being obtained or obtainable through the method according to claim 1.

28. The component according to claim 27, wherein the component is an electrode for a battery cell, such as a solid state battery cell.

29. A component for use in an energy storage device or an energy conversion device, the component comprising a first part and a second part, wherein the first part comprises particles of a ceramic material, and the second part is provided by a sheet having a plurality of through-thickness apertures;
wherein the second part is at least partially embedded in the first part.

30. The component according to claim 29, wherein the component is an electrode for a battery cell, such as a solid state battery cell, and the ceramic material is an electrode active material.

31. The component according to claim 30, wherein the first part comprises an ionically-conductive constituent that is distributed between the particles of the electrode active material, the ionically-conductive constituent having an ionic conductivity greater than 10-10 S Cm−1 and a melting point of 900° C. or less.

32. The component according to claim 31, wherein the ionically-conductive constituent comprises lithium, boron and optionally carbon as component elements.

33. The component according to claim 32, wherein the ionically-conductive component is selected from the group consisting of Li3BO3 and Li3-xB1-xCxO3, wherein 0<x<1.

34. The component according to claim 29, wherein the second part comprises iron or steel (including stainless steel).

35. The component according to claim 29, the component having a first face and a second face opposed to the first face, wherein the second part is aligned with the first face and the distance of the second part from the first face is 33% to 66% of the thickness of the component.

36. The component according to claim 29, the component having a first face and a second face opposed to the first face, wherein the sheet comprises a first portion, a second portion and a linking portion connecting the first and second portions, the first and second portions being aligned with the first face and being at different distances from the first face.

37. The component according to claim 36, wherein the sheet comprises a third portion and a further linking portion connecting the second and third portions, the third portion being aligned with the first face and being displaced from the first and second portions.

38. The component according to claim 36, wherein the mass per unit area of the linking portion of the sheet is less than the mass per unit area of the first portion of the sheet.

39. The component according to claim 38, wherein the linking portion of the sheet comprises at least one through-thickness opening that encompasses a greater area than each of the through-thickness apertures in the first portion of the sheet.

40. An energy storage device or energy conversion device comprising a component according to claim 27.

41. The energy storage device or energy conversion device according to claim 40, wherein the device is selected from the group consisting of: batteries, capacitors, fuel cells (including solid oxide fuel cells and polymer electrolyte fuel cells), photovoltaic devices, piezoelectric devices, and thermoelectric converters.

42. A solid state battery cell comprising a component according to claim 27, wherein the component is an electrode, the battery cell further comprising an electrolyte layer disposed on a face of the electrode.
